(19) United States
(12) Patent Application Publication
(10) Pub. No.: US 2023/0196777 A1
(43) Pub. Date: Jun. 22, 2023

(54) STORE ENTRY MANAGEMENT SYSTEM, STORE ENTRY MANAGEMENT METHOD, AND RECORDING MEDIUM

(71) Applicant: NEC CORPORATION, Minato-ku,Tokyo (JP)

(72) Inventor: Maya TAKABATAKE, Tokyo (JP)

(73) Assignee: NEC Corporation, Minato-ku, Tokyo (JP)

(21) Appl. No.: 17/925,669

(22) PCT Filed: May 11, 2021
(86) PCT No.: PCT/JP2021/017890

§ 371 Date: Nov. 16, 2022

(30) Foreign Application Priority Data
May 25, 2020 (JP) 2020-090273

(51) Int. Cl. G06V 20/52; G06T 5/50; G06V 40/16; G06F 21/32

(52) U.S. Cl. CPC G06V 20/52; G06T 5/50; G06V 40/172; G06F 21/32; G06V 2201/07; G06T 2207/20221; G06T 2207/30201; G06T 2207/30242

(57) ABSTRACT

A store entry management device comprises: a monitoring image acquisition unit that acquires a monitoring image of an area near an entrance of a store and including one or more customers before the one or more customers enters the store; a determination unit that determines the number of customers included in the monitoring image; an authenticating image acquisition unit that acquires an authenticating image including at least a portion of the head of a first customer, who is in an imaged area for performing authentication and is one individual among the one or more customers; and an output unit that outputs the acquired authenticating image, wherein the output unit outputs another monitoring image at least one of before and after the output of the authenticating image if the determination unit determines that a second customer aside from the first customer is included in the monitoring image.

### TECHNICAL FIELD

The present disclosure relates to a store entry management device that captures a face image of a customer when the customer enters a store.

### BACKGROUND ART

Due to a shortage of manpower, the number of unattended stores and labor-saving stores is increasing. In such an unattended store or the like, there is a system that executes biometric authentication using biometric data of a customer, for example, face data or iris data, and permits the user to enter the store after confirmation of success of the biometric authentication. PTL 1 discloses a technique for preventing a person entering a store or the like from being replaced by using captured images before and after entering the store. PTL 2 discloses a technique of managing a registered customer as a tailgating group of the registered customer when the registered customer enters a store with another customer.

### CITATION LIST

### Patent Literature

[PTL 1] JP 2006-132195 A
[PTL 2] JP 2009-281039 A

### SUMMARY OF INVENTION

### Technical Problem

In a case where only registered customers can enter the store at the time of entrance, biometric authentication (for example, face authentication) of the registered customers is performed at the entrance. However, when the biometric authentication is successful and the registered customer enters the store, a so-called tailgating may occur in which a customer other than the registered customer enters the store together. In many cases, a registered customer intentionally takes an acquaintance with a companion, but this may include a case where another person enters the store without permission when the registered customer enters the store. However, PTL 1 and PTL 2 do not disclose a method of preventing entrance of tailgating as described above.

The present disclosure has been made in view of the above problems, and an object of the present disclosure is to provide a store entry management device or the like that can prevent accompanying customers at the time of entering a store.

### Solution to Problem

In view of the above problems, a store entry management device according to a first aspect of the present disclosure includes:

a monitoring image acquisition means configured to acquire a monitoring image near an entrance of a store including one or more customers before the one or more customers enter the store;

a determination means configured to determine the number of customers included in the monitoring image;

an authenticating image acquisition means configured to acquire an authenticating image including at least a part of a head of a first customer, who is in an imaged area for performing authentication and is one individual among the one or more customers; and

an output means configured to output the acquired authenticating image, wherein

when the determination means determines that the monitoring image includes a second customer other than the first customer, the output means outputs the monitoring image at least either before or after an output of the authenticating image.

According to a second aspect of the present disclosure, a store entry management system includes:

the store entry management device described above;

a first camera configured to capture a monitoring image near an entrance of a store including one or more customers before the one or more customer enter the store;

a second camera configured to capture an authenticating image including at least a part of a head of a first customer, who is in an imaged area for performing authentication and is one individual among the one or more customers; and

an authentication device configured to execute the authentication using the authenticating image.

According to a third aspect of the present disclosure, a store entry management method includes:

acquiring a monitoring image near an entrance of a store including one or more customers before the one or more customers enter the store;

determining a number of customers included in the monitoring image;

acquiring an authenticating image including at least a part of a head of a first customer, who is in an imaged area for performing authentication and is one individual among the one or more customers; and

outputting the acquired authenticating image, wherein

when it is determined in the determining that the monitoring image includes a second customer other than the first customer, the monitoring image is output at least either before or after the output of the authenticating image.

According to a fourth aspect of the present disclosure, a store entry management program for causing a computer to execute includes:

acquiring a monitoring image near an entrance of a store including one or more customers before the one or more customers enter the store;

determining a number of customers included in the monitoring image;

acquiring an authenticating image including at least a part of a head of a first customer, who is in an imaged area for performing authentication and is one individual among the one or more customers; and

outputting the acquired authenticating image, wherein

when it is determined in the determining that the monitoring image includes a second customer other than the first customer, the monitoring image is output at least either before or after the output of the authenticating image.

The store entry management program may be stored in a non-transitory computer-readable/writable recording medium.

### Advantageous Effects of Invention

According to the present disclosure, it is possible to provide a store entry management device or the like capable of preventing accompanying of a customer at the time of entering a store.

### BRIEF DESCRIPTION OF DRAWINGS

FIG. 1 is a block diagram illustrating a configuration example of a store entry management system according to a first example embodiment of the present disclosure.

FIG. 2 is a schematic diagram illustrating an operation example of the store entry management system.

FIG. 3 is a block diagram illustrating a configuration example of a store entry management device according to the first example embodiment of the present disclosure.

FIG. 4 is a flowchart illustrating an operation example of the store entry management device according to the first example embodiment of the present disclosure.

FIG. 5 is a diagram illustrating an example of a monitoring image.

FIG. 6 is a diagram illustrating an example of an authenticating image.

FIG. 7 is a block diagram illustrating a configuration example of a store entry management system according to a second example embodiment of the present disclosure.

FIG. 8 is a flowchart illustrating an operation example of a store entry management device according to the second example embodiment of the present disclosure.

FIG. 9 is a diagram illustrating an example of an authenticating image.

FIG. 10 is a block diagram illustrating a configuration example of a store entry management device according to a third example embodiment of the present disclosure.

FIG. 11 is a block diagram illustrating a configuration example of a computer device applicable in each example embodiment.

### EXAMPLE EMBODIMENT

In the retail industry, for the purpose of improving operation efficiency and expanding to small trading areas, introduction of labor-saving or unmanned stores (hereinafter, these are collectively referred to as “labor-saving stores”) has been promoted in which, for example, a computer system reduces the number of employees working related to customer service support, in-store monitoring, delivery management, facility management, and the like, including registration and settlement of purchased products, and reduces or eliminates the number of resident employees.

Generally, a labor-saving store is smaller in size and has a limited floor area than a normal store. Unlike ordinary stores installed along public roads in urban areas and suburban areas, these labor-saving stores may also be installed in specific places such as office buildings, factories, station premises, hotels, and apartment buildings. For example, a store (for example, a so-called micro store) in which a shelf is installed at a corner of a place other than a general store such as an office may also be included in the labor-saving store. While a store clerk is absent from a normal store, a temporary labor-saving store may be included in the labor-saving store.

In order to ensure security in such a labor-saving store, a system has been developed in which biometric authentication of a customer is executed at the time of entrance to identify the identity of the customer, and occurrence of a crime is suppressed. In such a system, a biometric image (for example, a face image or an iris image) of a customer is photographed at the time of entrance, and only a registered customer can enter the store, but there is a case where a companion of the customer occurs. Therefore, in the following, a store entry management device and the like capable of preventing accompanying of customers will be described in each example embodiment.

In each example embodiment, a case where the face authentication is adopted as an example of the biometric authentication will be described, but it is also possible to achieve the biometric authentication by using another authentication method, for example, iris authentication.

Hereinafter, each example embodiment will be described in detail with reference to the drawings. In the following description of the drawings, the same or similar parts are denoted by the same or similar reference numerals. However, the drawings schematically illustrate configurations in the example embodiments of the present disclosure. Further, the example embodiment of the present disclosure described below is an example, and can be appropriately changed within the scope of the same essence.

### First Example Embodiment

(Store Entry Management System)

Hereinafter, a store entry management system 100 according to a first example embodiment of the present disclosure will be described with reference to the drawings.

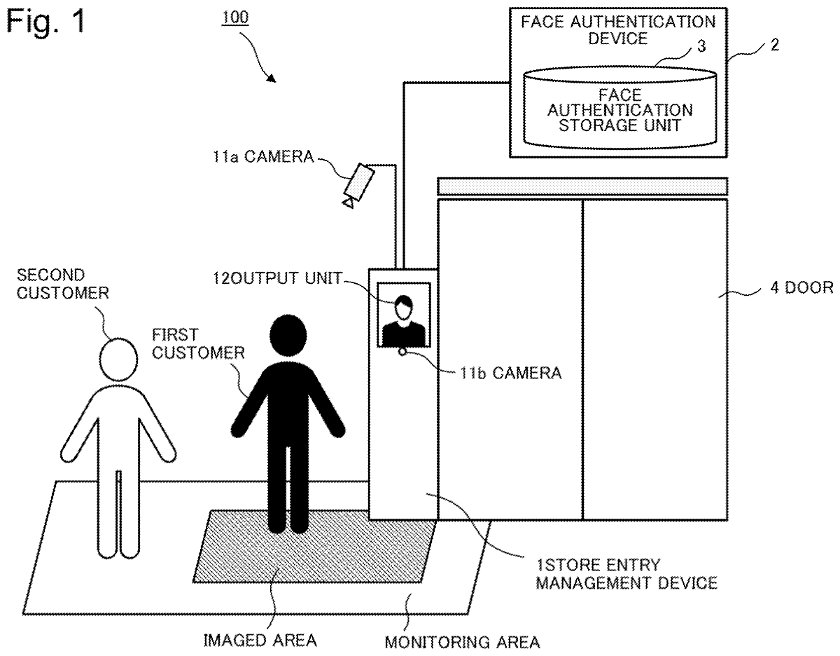

FIG. 1 is a diagram illustrating a schematic configuration of the store entry management system 100. As illustrated in FIG. 1, the store entry management system 100 includes a store entry management device 1 and a face authentication device 2. The store entry management device 1 and the face authentication device 2 are communicably connected to each other via a wired or wireless communication line. The communication may include a communication line such as the Internet or an intranet. The face authentication device 2 may be provided inside the store entry management device 1.

The store entry management device 1 is a device that manages entrance by photographing a face image of a customer entering a store and performing face authentication using the face image. The store entry management device 1 includes a camera 11a (also referred to as a first camera), a camera 11b (also referred to as a second camera), and an output unit 12.

The camera 11a is a camera for capturing an image around an entrance of a store, and is, for example, a security camera for capturing a security image. The camera 11b is an authentication camera that captures an authenticating image (for example, a face image) of a customer. In FIG. 1, the number of cameras is two, but the number is not limited thereto. In the present example embodiment, for convenience of description, it is assumed that there are two cameras. The cameras 11a and 11b are installed so as to capture images at different angles. As illustrated in FIG. 1, the camera 11b captures an image of an imaged area, and the camera 11a captures an image of a monitoring area including the imaged area and wider than the imaged area. The store entry management device 1 captures an authenticating image for the first customer present in the imaged area. At this time, the following description will be given assuming that the unregistered second customer is in the monitoring area for tailgating.

The output unit 12 is an output device such as a monitor or a display. The output unit 12 may be an input/output device such as a touch panel.

The face authentication device 2 (also referred to as an authentication device) executes the biometric authentication (face authentication) of the customer who enters the store using the image applicable to the authentication including at least a part of the head of the customer photographed by the store entry management device 1. The at least part of the head of the customer is, for example, an image of a face. The face image may include a front facing image, an oblique facing image, and a lateral facing image. In the case of the iris authentication, an image of the eye (iris) is obtained. The image applicable to the authentication including at least a part of the head of the customer is a face image applicable to the face authentication. In the case of the iris authentication, an image of the eye applicable to the iris authentication is obtained. In the following, a case where face authentication is adopted as an example of biometric authentication will be described.

The face authentication device 2 receives a face image of a customer photographed by the store entry management device 1, and performs face authentication using the face image. The face authentication device 2 includes a face authentication storage unit 3, and feature data of a face image of a customer acquired in advance is stored in the face authentication storage unit 3 in association with information (customer identifier (ID), customer name, and the like) for specifying the customer. The face authentication device 2 receives a request for face authentication from the store entry management device 1 together with the face image of the customer photographed by the camera 11b, and determines whether the feature data extracted from the face image of the customer matches the feature data stored in the face authentication storage unit 3. When the matching rate is equal to or more than a predetermined matching rate (for example, 97%), it may be determined that both the data match, that is, the authentication succeeds. The face authentication device 2 transmits the determination result to the store entry management device 1. When the determination result indicates that the authentication has succeeded, the face authentication device 2 may transmit information specifying the customer to the store entry management device 1 together with the fact that the authentication has succeeded.

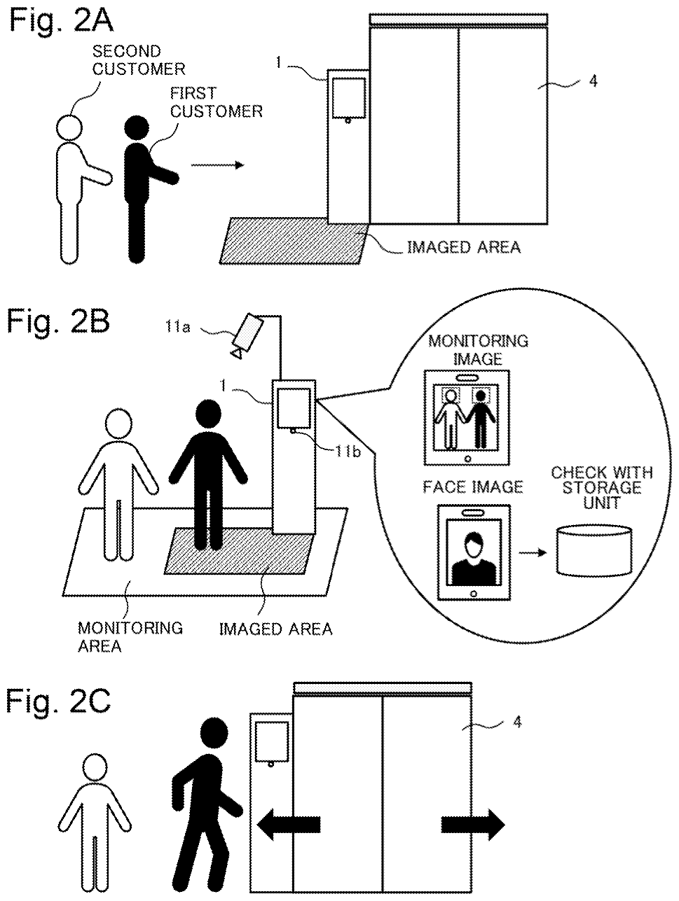

An operation of the store entry management system 100 will be described with reference to FIG. 2. First, the first customer and the second customer approach the store entry management device 1 to enter the store (see FIG. 2(a)). When the first customer enters the imaged area of the store entry management device 1, the store entry management device 1 causes the camera 11a to photograph a face image of the customer in the imaged area, and causes the camera 11a to photograph a monitoring image of the monitoring area (see FIG. 2(b)). The store entry management device 1 outputs the monitoring image captured by the camera 11a and the face image captured by the camera 11b to the output unit 12 in order or simultaneously. This is to inform the first customer and the second customer that the second customer is photographed by the camera 11a, and is output to suppress tailgating of the second customer. In the monitoring image, a rectangular region may be superimposed on the face images of the first customer and the second customer to highlight that the face image of the second customer has been photographed.

The store entry management device 1 stores the photographed face image of the first customer in an internal storage unit, and further transmits the face image to the face authentication device 2. When the received face image matches the face image stored in the face authentication storage unit 3, the face authentication device 2 notifies the store entry management device 1 of the successful authentication. When the store entry management device 1 is notified of the successful authentication, the store entry management device 1 unlocks the door 4 for entering the store (see FIG. 2(c)). Before and after this unlocking, the store entry management device 1 displays the monitoring image. The monitoring image may be displayed with a warning message. Accordingly, it is possible to suppress tailgating of the unregistered second customer. When the output unit 12 displays the monitoring image, the store entry management device 1 may cause the output unit 12 to output a message (voice or text) prompting the second customer to request the face authentication using the camera 11b and to newly register the face authentication.

The store entry management device 1 may unlock the door 4 even when the second customer is not registered. The store entry management device 1 may take an image of the face image of the unregistered second customer who wishes to enter the store via the camera 11b and store the image in the storage unit, thereby temporarily recognizing the entry, that is, unlocking the door 4. This is for customer convenience (for example, for children in the case of parent-child relationship). Preferably, the store entry management device 1 outputs a notification requesting the unregistered second customer to register before entering the store to the output unit 12, and displays the photographed face image of the customer on the output unit 12. This is to prevent a crime such as theft by notifying the second customer that the face image of the second customer has been registered. Further, the purpose is to easily confirm the physical characteristics of the second customer even when a crime occurs.

Hereinafter, the store entry management device 1 will be described in detail.

(Store Entry Management Device)

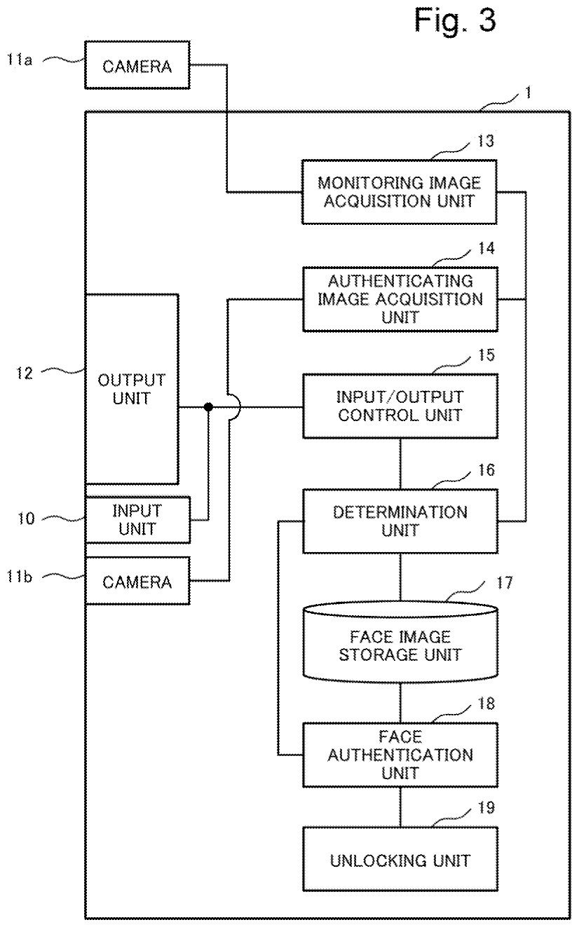

As illustrated in FIG. 3, the store entry management device 1 includes cameras 11a and 11b, an output unit 12, an input unit 10, a monitoring image acquisition unit 13, an authenticating image acquisition unit 14, an input/output control unit 15, a determination unit 16, a face image storage unit 17, a face authentication unit 18, and an unlocking unit 19.

The camera 11a captures a monitoring video of the monitoring area including the imaged area. The camera 11b captures an authenticating image including at least a part of the head of the customer who is in the imaged area and enters the store. The cameras 11a and 11b may automatically execute photographing with the presence of the face of the first customer at a position (for example, the center of the image) suitable for photographing the face image in the imaged area as a trigger. The cameras 11a and 11b may execute image capturing when receiving an image capturing start instruction from the customer via the input unit 10 described later. The cameras 11a and 11b may simultaneously capture images or may capture images at different timings.

The output unit 12 is a device for outputting the monitoring image, the authenticating image, and the instruction to the customer captured by the cameras 11a and 11b, and is, for example, a display or a monitor.

When the monitoring image includes a plurality of customers (for example, the first customer and the second customer illustrated in FIG. 1), the output unit 12 superimposes a display for emphasizing the second customer on the monitoring image on a part of or around the second customer included in the monitoring image, and outputs the superimposed display. For example, the output unit 12 outputs a monitoring image in which at least a part of the body of the second customer is emphasized using at least one of characters, marks, decorations, and a rectangular region. Here, the highlighted monitoring image means that at least a part of the body of the second customer in the monitoring image and at least one of a character, a mark, a decoration, and a rectangular region are output in a superimposed manner. The output unit 12 may also perform the above-described superimposition processing on the first customer in the monitoring image and output the first customer.

When the monitoring image includes the second customer, the output unit 12 outputs a message prompting the second customer to photograph the authenticating image. The message is, for example, “(at a position different from the output position of the image of the second customer, or superimposed on the image,) To enter the store, the face authentication processing is also necessary for this customer. Please take an authenticating image.” or the like.

When the determination unit 16 described later determines that the monitoring image includes the second customer other than the first customer, the output unit 12 outputs the monitoring image at least either before or after the output of the authenticating image. This is because the second customer included in the monitoring image is already recognized (photographed) by the store entry management device 1, and the second customer is also notified that the authentication processing is necessary at the time of entering the store.

The input unit 10 is a device for receiving an instruction from a customer, and receives the instruction via, for example, an authentication start button (selection button for whether to execute authentication) displayed on the output unit 12, a touch of an image capturing start button, or the like. In addition, the input unit 10 accepts, from the customer, a request that does not execute authentication and desires temporary store entry via a touch of a temporary store entry button or the like. The output unit 12 and the input unit 10 may be an integrated device, for example, a touch panel device.

The monitoring image acquisition unit 13 acquires a monitoring image near an entrance of a store including one or more customers from the camera 11a before the customer enters the store. The monitoring image acquisition unit 13 transmits the acquired authenticating image to the determination unit 16.

The authenticating image acquisition unit 14 acquires an authenticating image including at least a part of the head of the customer (first customer) which is in the imaged area for authentication from the camera 11b. The authenticating image acquisition unit 14 transmits the acquired authenticating image to the determination unit 16.

The input/output control unit 15 controls the input unit 10 and the output unit 12. For example, an instruction from a customer is received from the input unit 10, and images captured by the cameras 11a and 11b or a message directed to the customer is output to the output unit 12.

The determination unit 16 determines the number of customers included in the monitoring image. When the number of customers included in the monitoring image is plural, for example, when there are the first customer and the second customer, the determination unit 16 determines that the number of customers is “2”. In a case where the number of customers is plural, the determination unit 16 notifies the output unit 12 of the fact.

The determination unit 16 stores the data (hereinafter, it is described as face image data) of the face image acquired from the authenticating image acquisition unit 14 in the face image storage unit 17. Further, when the determination unit 16 accepts, via the input unit 10, that the customer desires to temporarily enter the store without executing authentication by touching the temporary store entry button or the like, the authenticating image for the temporary store entry is acquired from the authenticating image acquisition unit 14 and temporarily stored in the face image storage unit 17.

The face image storage unit 17 stores face image data. The face image storage unit 17 may delete face image data to be stored at predetermined intervals (for example, one month).

The face authentication unit 18 acquires face image data stored in the face image storage unit 17, and transmits a request for face authentication to the face authentication device 2 together with the face image data. The face authentication unit 18 receives a result of the face authentication (authentication success or authentication failure) from the face authentication device 2. When the result of the face authentication is successful, the face authentication unit 18 notifies the unlocking unit 19 of an unlock instruction.

When receiving an unlocking instruction from the face authentication unit 18, the unlocking unit 19 unlocks the door 4.

In addition, the face authentication unit 18 may notify the unlocking unit 19 of an unlock instruction when receiving a notification about a customer who wishes to temporarily enter the store from the determination unit 16 and confirming that the face image of the customer is stored in the face image storage unit 17. At this time, the input/output control unit 15 may output, to the output unit 12, information indicating a request for photographing a face image before entering the store and a request for finalized registration of face authentication to an unregistered customer.

After photographing the face image of the second customer before entering the store, the input/output control unit 15 preferably displays the photographed face image of the customer on the output unit 12. This is to prevent a crime such as theft by notifying the unregistered customer that the face image of the customer has been registered. Further, the purpose is to easily confirm the physical characteristics of the customer even when a crime occurs.

(Operation of Store Entry Management Device)

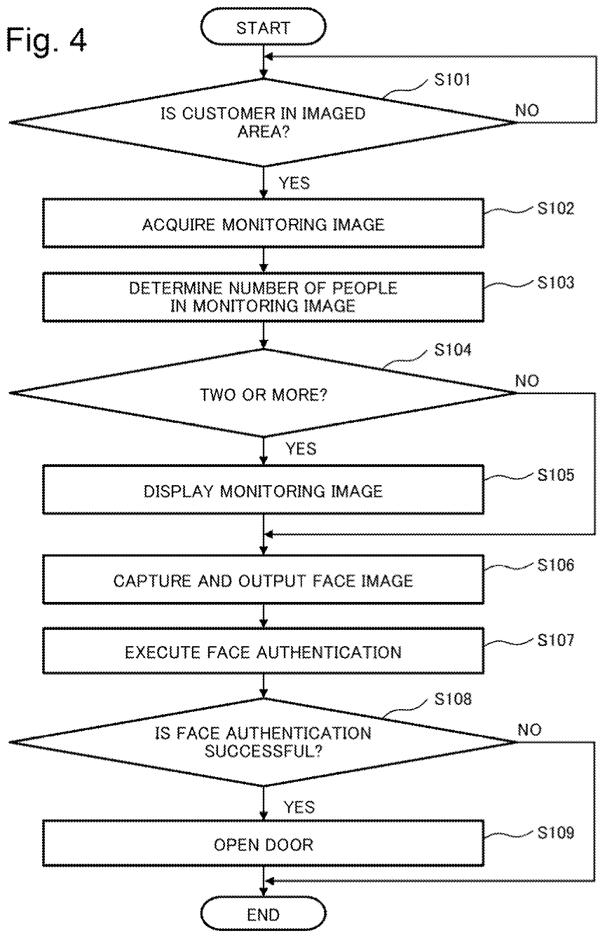

The operation of the store entry management device 1 will be described with reference to a flowchart illustrated in FIG. 4.

In Step S101, when the authenticating image acquisition unit 14 of the store entry management device 1 detects that the customer appears in the imaged area of the camera 11b, or detects that the photographing start button of the input unit 10 is pressed by the customer in the imaged area, the process proceeds to Step S102.

In Step S102, the monitoring image acquisition unit 13 causes the camera 11a to capture monitoring images of customers (the first customer and the second customer) in the monitoring area, and acquires the monitoring images. The monitoring image acquisition unit 13 delivers the acquired monitoring image to the determination unit 16.

In Step S103, the determination unit 16 determines the number of customers included in the acquired monitoring image. For example, in the case of FIG. 1, it is determined that the two customers are the first customer and the second customer.

In Step S104, in a case where the number of customers included in the monitoring image determined by the determination unit 16 is plural, that is, two or more customers, the process proceeds to Step S105. In a case where the number of customers is not plural, the process proceeds to Step S106.

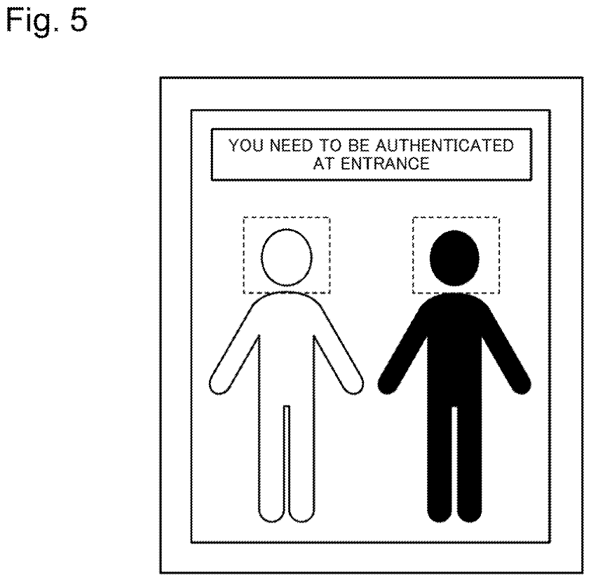

In Step S105, the determination unit 16 passes the monitoring image in which two or more customers appear to the input/output control unit 15, and the input/output control unit 15 outputs the monitoring image to the output unit 12. At this time, the output unit 12 outputs a monitoring image in which at least a part of the body of the second customer is emphasized using at least one of characters, marks, decorations, and a rectangular region (see FIG. 5).

The output unit 12 may output the image a plurality of times before and after Step S106. The output unit 12 may also output a monitoring image highlighted in a rectangular area or the like to the first customer in the monitoring image. The output unit 12 may output a message prompting the second customer to photograph the authenticating image. This is because the second customer included in the monitoring image is already recognized by the store entry management device 1, and the second customer is also notified that the authentication process is necessary when entering the store.

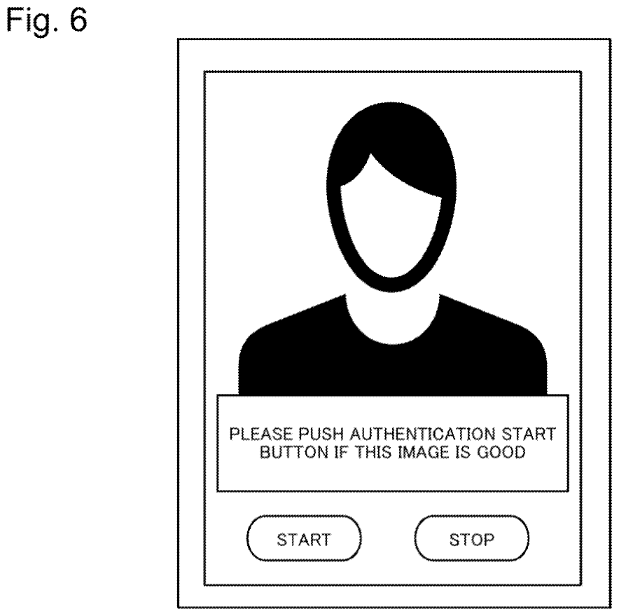

In Step S106, the camera 11b photographs the face image of the first customer in the imaged area, and the authenticating image acquisition unit 14 acquires the face image. The authenticating image acquisition unit 14 delivers the acquired face image to the determination unit 16. The determination unit 16 outputs the face image to the output unit 12 via the input/output control unit 15. This is to cause the first customer to confirm the face image to be authenticated. At the time of outputting the face image, the output unit 12 displays an authentication start button (see FIG. 6), and receives selection of the button via the input unit 10. The input unit 10 transmits a notification of authentication start to the determination unit 16 via the input/output control unit 15. When receiving the notification of authentication start, the determination unit 16 stores the data of the face image in the face image storage unit 17. The determination unit 16 transmits the fact that the face image data has been stored in the face image storage unit 17, that is, the notification of the face authentication request to the face authentication unit 18. The notification may include an identifier or the like for identifying the face image data.

In Step S107, the face authentication unit 18 that has received the notification of the face authentication request executes face authentication of the first customer. Specifically, when receiving the notification of the face authentication request, the face authentication unit 18 acquires face image data from the face image storage unit 17, and transmits the notification of the face authentication request to the face authentication device 2 together with the acquired face image data.

In Step S108, when receiving the authentication result from the face authentication device 2, the face authentication unit 18 determines whether the authentication result is authentication success or authentication failure. When the authentication is successful, the face authentication unit 18 notifies the unlocking unit 19 of an unlock instruction.

In Step S109, when receiving an unlocking instruction from the face authentication unit 18, the unlocking unit 19 unlocks a door 4 at the store entrance. This door unlocking is for the first customer who has been successfully authenticated to enter the store.

This is the end of the operation of the store entry management device 1.

(Effects of First Example Embodiment)

According to the first example embodiment of the present disclosure, it is possible to prevent accompanying of a customer at the time of entering a store. This is because, when the determination unit 16 determines that the monitoring image includes the second customer other than the first customer, the output unit 12 outputs the monitoring image at least either before or after the output of the authenticating image. This monitoring image prevents the second customer from entering the store together.

### Second Example Embodiment

(Store Entry Management System)

In the first example embodiment of the present disclosure, the door of the store entrance is opened for the first customer who has succeeded in authentication. However, the security is stronger when the door of the store entrance is opened after the authentication process or the temporary entrance process (face image registration) of the first customer and the second customer is completed. Therefore, in the second example embodiment, a store entry management system will be described in which the door of the store entrance is opened after the authentication process and the temporary store entrance process of the first customer and the second customer appearing in the monitoring image are completed.

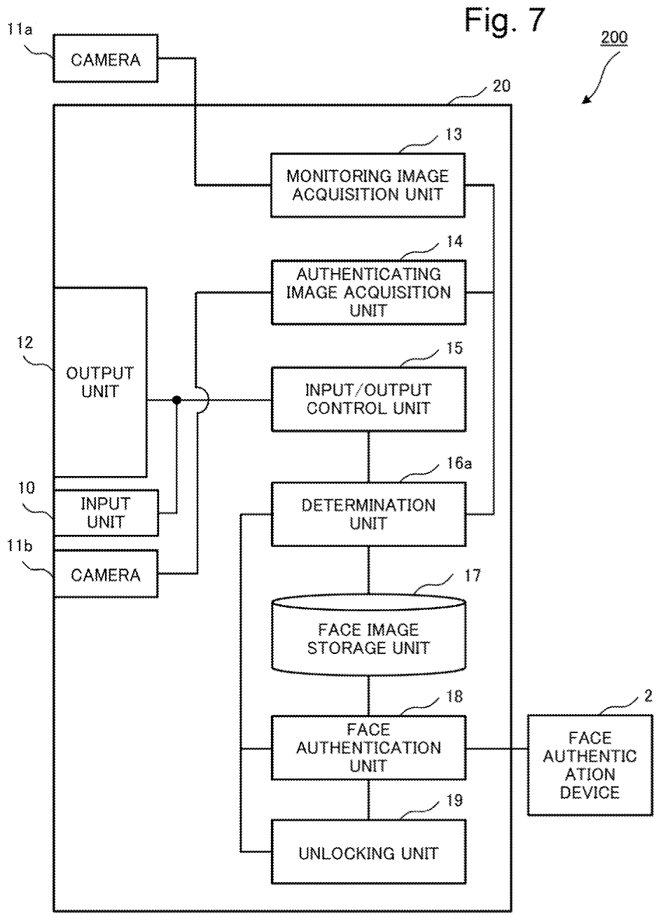

FIG. 7 illustrates a store entry management system 200 according to a second example embodiment. The store entry management system 200 includes a store entry management device 20 and a face authentication device 2. The device or the like seen by the customer and the operation performed by the customer (see FIGS. 1 and 2) are similar to those in the first example embodiment.

(Store Entry Management Device)

As illustrated in FIG. 7, the store entry management device 20 according to the second example embodiment includes cameras 11a and 11b, an output unit 12, an input unit 10, a monitoring image acquisition unit 13, an authenticating image acquisition unit 14, an input/output control unit 15, a determination unit 16a, a face image storage unit 17, a face authentication unit 18, and an unlocking unit 19.

When the number of customers included in the monitoring image does not match the number of authenticating images acquired by the authenticating image acquisition unit 14, the determination unit 16a causes the output unit 12 to output an alarm via the input/output control unit 15.

When the number of customers included in the monitoring image matches the number of authenticating images acquired by the authenticating image acquisition unit 14, the determination unit 16a notifies the unlocking unit 19 to unlock the door 4 at the store entrance.

Other configurations are the same as those of the first example embodiment (see FIG. 3).

(Operation of Store Entry Management Device)

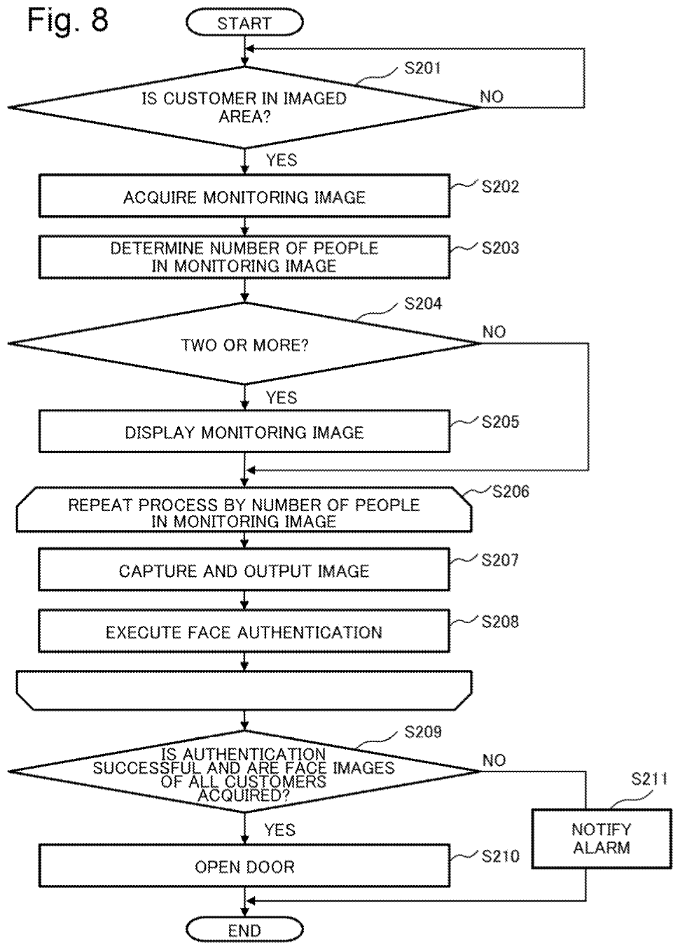

The operation of the store entry management device 20 will be described with reference to a flowchart illustrated in FIG. 8.

Steps S201 to S205 are similar to Steps S101 to S105 of the first example embodiment.

In Step S206, the determination unit 16a executes Steps S207 and S208 for the number of customers (the first customer and the second customer) counted in Step S203.

In Step S207, the camera 11b photographs the face image of the first customer in the imaged area, and the authenticating image acquisition unit 14 acquires the face image. The authenticating image acquisition unit 14 delivers the acquired face image to the determination unit 16a. The determination unit 16 outputs the face image to the output unit 12 via the input/output control unit 15. At the time of outputting the face image, the output unit 12 displays an authentication start button (see FIG. 6), and receives selection of the button via the input unit 10. The input unit 10 transmits a notification of authentication start to the determination unit 16a via the input/output control unit 15. When receiving the notification of authentication start, the determination unit 16a stores the data of the face image in the face image storage unit 17. The determination unit 16a transmits the fact that the face image data is stored in the face image storage unit 17, that is, a notification of the face authentication request to the face authentication unit 18. The notification may include an identifier or the like for identifying the face image data.

In Step S208, the face authentication unit 18 that has received the notification of the face authentication request executes face authentication of the first customer. Specifically, when receiving the notification of the face authentication request, the face authentication unit 18 acquires face image data from the face image storage unit 17, and transmits the notification of the face authentication request to the face authentication device 2 together with the acquired face image data.

Steps S207 and S208 are repeated for the number of customers (the first customer and the second customer). Here, the first customer is a registered customer, but the second customer is an unregistered customer, does not desire authentication registration, and may enter the store only temporarily.

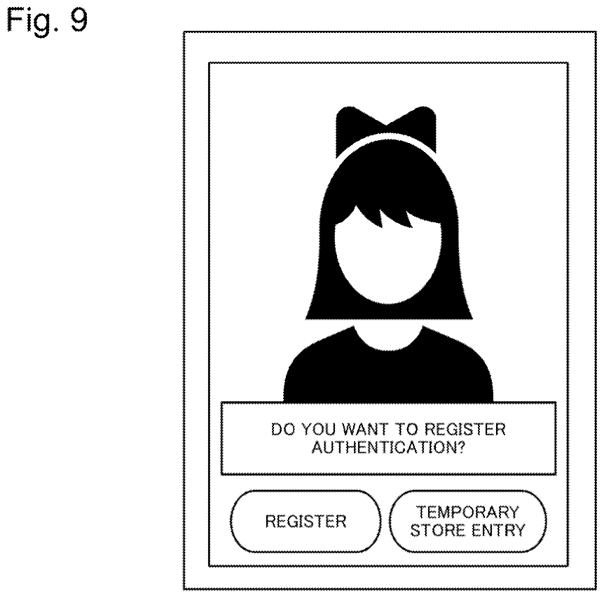

In this case, when the authenticating image of the second customer is displayed in Step S207, the determination unit 16a causes the output unit 12 to display the buttons of “register” and “temporary store entry” (see FIG. 9) via the input/output control unit 15, and causes the second customer to select the buttons. It is assumed that the input unit 10 receives selection of “temporary store entry” by the second customer, and the determination unit 16a receives the selection via the input/output control unit 15. In this case, the determination unit 16a acquires a face image of the second customer, attaches information indicating temporary store entry to the face image, and stores the face image in the face image storage unit 17.

In Step S208, the face authentication unit 18 requests the face authentication device 2 to authenticate the first customer. Since the second customer temporarily enters the store, authentication is not requested.

In Step S209, when receiving the authentication result (authentication success or authentication failure) for the first customer from the face authentication device 2, the face authentication unit 18 notifies the determination unit 16a of the authentication result. When the result of the authentication is successful, the determination unit 16a determines whether the number of customers included in the monitoring image matches the number of authenticating images acquired by the authenticating image acquisition unit. If they do not match, the determination unit 16a causes the output unit 12 to output an alarm (alarm notification in Step S211). In the alarm output, a message requesting photographing of the authenticating image is presented for the number of customers included in the monitoring image. In the alarm, a lamp (not illustrated) may blink, and an alarm sound or a voice message may be broadcast from a speaker (not illustrated).

In Step S209, whether the number of customers and the number of authenticating images match is determined in order to allow temporary entrance for convenience of customers if face images of all customers can be acquired even if all customers temporarily enter a store and face authentication is not performed.

Further, when the registered customer performs the authentication process, the determination unit 16a instructs the unlocking only when the result of the authentication is the successful authentication because when the registered first customer is included in the customers and the authentication of the first customer is a failure, the determination unit does not allow the entry to all the customers including the first customer who may possibly perform fraud.

In Step S209, when the number of customers matches the number of authenticating images stored in the face image storage unit 17 and the authentication result of the authenticated first customer is successful, the determination unit 16a notifies the unlocking unit 19 of an unlock instruction. In Step S210, when receiving an unlocking instruction from the determination unit 16a, the unlocking unit 19 unlocks the door 4 at the store entrance.

This unlocking of the door 4 is for entrance of the first customer who has succeeded in authentication and the second customer who has registered the face image for temporary entrance.

This is the end of the operation of the store entry management device 20.

(Effects of Second Example Embodiment)

According to the second example embodiment of the present disclosure, it is possible to prevent accompanying of a customer at the time of entering a store. This is because, when the determination unit 16a determines that the monitoring image includes the second customer other than the first customer, the output unit 12 outputs the monitoring image at least either before or after the output of the authenticating image.

Further, in the second example embodiment, the determination unit 16a causes the output unit 12 to output an alarm when the number of customers included in the monitoring image does not match the number of authenticating images acquired by the authenticating image acquisition unit 14. Accordingly, it is possible to prevent a customer who does not register a face image from entering the store.

### Third Example Embodiment

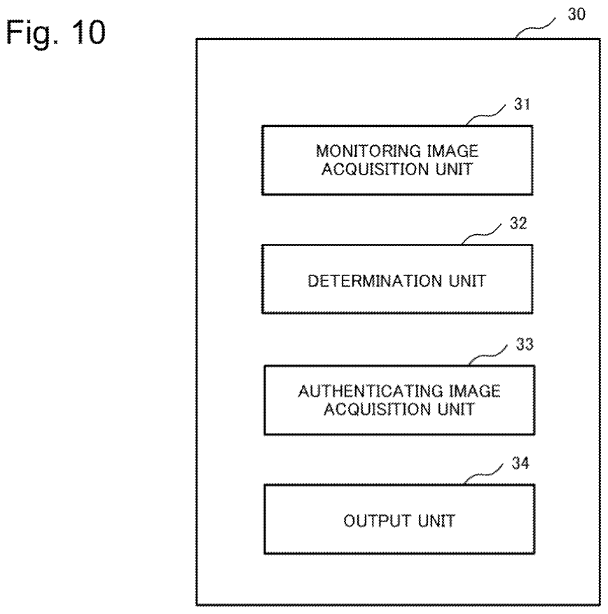

A store entry management device 30 according to a third example embodiment of the present disclosure will be described with reference to FIG. 10. The store entry management device 30 is a minimum configuration example of the store entry management devices 1 and 20 in the first and second example embodiments.

As illustrated in FIG. 10, the store entry management device 30 includes a monitoring image acquisition unit 31, a determination unit 32, an authenticating image acquisition unit 33, and an output unit 34.

The monitoring image acquisition unit 31 acquires a monitoring image near an entrance of a store including one or more customers before the customer enters the store.

The determination unit 32 determines the number of customers included in the monitoring image.

The authenticating image acquisition unit 33 acquires an authenticating image including at least a part of the head of the first customer who is in the imaged area for performing authentication and is one individual among the customers.

The output unit 34 outputs the acquired authenticating image. Further, when the determination unit 32 determines that the monitoring image includes the second customer other than the first customer, the output unit 34 outputs the monitoring image at least either before or after the output of the authenticating image.

According to the third example embodiment of the present disclosure, it is possible to prevent accompanying of a customer at the time of entering a store. This is because, when the determination unit 32 determines that the monitoring image includes the second customer other than the first customer, the output unit 34 outputs the monitoring image at least either before or after the output of the authenticating image.

(Computer Device)

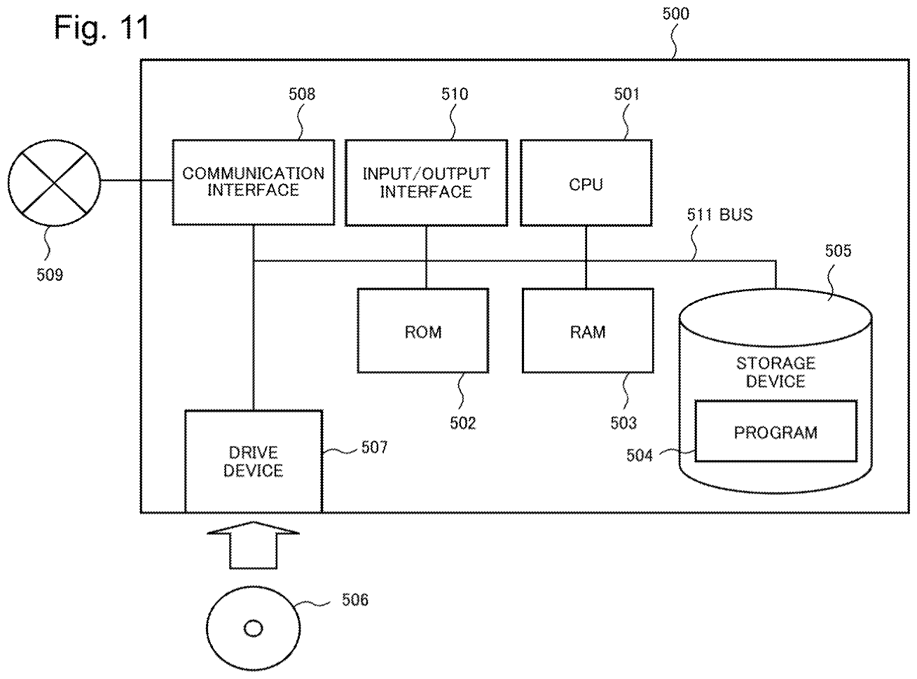

In each of the example embodiments of the present disclosure described above, some or all of the components of the store entry management device or the face authentication device (hereinafter, referred to as a store entry management device or the like of the present disclosure) illustrated in FIGS. 1, 3, 7, and 10 can also be achieved by using, for example, an arbitrary combination of a computer (information processing) device 500 and a program as illustrated in FIG. 11. As an example, the computer device 500 includes the following configuration.
CPU 501
ROM 502
RAM 503
Storage device 505 storing program 504 and other data
Drive device for reading and reading recording medium 506
Communication interface 508 connected with communication network 509
Input/output interface 510 for inputting/outputting data
Bus 511 connecting each component

Each component in each example embodiment such as the store entry management device of the present disclosure is achieved by the CPU 501 acquiring and executing the program 504 that achieves these functions. The program 504 that achieves the functions of the components such as the store entry management device of the present disclosure is stored in the storage device 505 or the RAM 503 in advance, for example, and is read by the CPU 501 as necessary. The program 504 may be supplied to the CPU 501 via the communication network 509, or may be stored in advance in the recording medium 506, and the drive device 507 may read the program and supply the program to the CPU 501.

There are various modifications of the method of achieving each device. For example, the store entry management device and the like of the present disclosure may be achieved by any combination of separate computer devices and programs for each component. A plurality of constituent elements included in the store entry management device or the like of the present disclosure may be achieved by an arbitrary combination of one computer device 500 and a program.

Some or all of the constituent elements of the store entry management device and the like of the present disclosure are achieved by other general-purpose or dedicated circuits, processors and the like, or a combination thereof. These may be configured by a single chip or may be configured by a plurality of chips connected via a bus.

Some or all of the components of the store entry management device and the like of the present disclosure may be achieved by a combination of the above-described circuit and the like and a program.

In a case where a part or all of each component such as the store entry management device of the present disclosure is achieved by a plurality of computer devices, circuits, and the like, the plurality of computer devices, circuits, and the like may be arranged in a centralized manner or in a distributed manner. For example, the computer device, the circuit, and the like may be achieved as a form in which each is connected via a communication network, such as a client and server system or a cloud computing system.

Although the present disclosure has been particularly shown and described with reference to the present example embodiment, the present disclosure is not limited to the above example embodiment. It will be understood by those of ordinary skill in the art that various changes in form and details may be made therein without departing from the spirit and scope of the present disclosure as defined by the claims.

This application is based upon and claims the benefit of priority from Japanese patent application No. 2020-090273, filed on May 25, 2020, the disclosure of which is incorporated herein in its entirety by reference.

### REFERENCE SIGNS LIST

1 store entry management device
2 face authentication device
3 face authentication storage unit
4 door
10 input unit
11a camera
11b camera
12 output unit
13 monitoring image acquisition unit
14 authenticating image acquisition unit
15 input/output control unit
16 determination unit
16a determination unit
17 face image storage unit
18 face authentication unit
19 unlocking unit
30 store entry management device
31 monitoring image acquisition unit
32 determination unit
33 authenticating image acquisition unit
34 output unit
100 store entry management system
200 store entry management system
500 computer device
504 program
505 storage device
506 recording medium
507 drive device
508 communication interface
509 communication network
510 input/output interface
511 bus

What is claimed is:

1. A store entry management system comprising:
a memory storing instructions; and
one or more processors configured to execute the instructions to:
acquire a monitoring image near an entrance of a store including one or more customers before the one or more customers enter the store;
determine the number of customers included in the monitoring image;
acquire an authenticating image including at least a part of a head of a first customer, who is in an imaged area for performing authentication and is one individual among the one or more customers; and
output the acquired authenticating image, wherein
output the monitoring image at least either before or after an output of the authenticating image when determining that the monitoring image includes a second customer other than the first customer.

2. The store entry management system according to claim 1, wherein
the one or more processors are further configured to execute the instructions to:
superimpose a display for highlighting the second customer on the monitoring image and outputs the display to a part of or around the second customer included in the monitoring image.

3. The store entry management system according to claim 1, wherein
the one or more processors are further configured to execute the instructions to:
output a voice or a text message prompting the second customer included in the monitoring image to capture the authenticating image.

4. The store entry management system according to claim 1, wherein
the one or more processors are further configured to execute the instructions to:
output an alarm when a number of the customers included in the monitoring image does not match a number of the authenticating images acquired.

5. The store entry management system according to claim 1, wherein,
the one or more processors are further configured to execute the instructions to:
receive, from the first customer, a selection as to whether to execute the authentication when the authenticating image is output, wherein
acquire the authenticating image for temporary entry and store the authenticating image in a storage when accepting that the first customer does not execute the authentication and wants to temporarily enter a store.

6. The store entry management system according to claim 1, wherein
the authentication is face authentication, and the authenticating image is a face image.

7. The store entry management system according to claim 1, further comprising:
a first camera configured to capture the monitoring image;
a second camera configured to capture the authenticating image; and
an authentication device configured to execute the authentication using the authenticating image, wherein
the one or more processors are further configured to execute the instructions to:
acquire, from the first camera, the monitoring image,
acquire, from the second camera, the authenticating image.

8. The store entry management system according to claim 7, wherein
a monitoring area to be imaged by the first camera includes an imaged area to be imaged by the second camera.

9. A store entry management method comprising:
acquiring a monitoring image near an entrance of a store including one or more customers before the one or more customers enter the store;
determining a number of customers included in the monitoring image;
acquiring an authenticating image including at least a part of a head of a first customer, who is in an imaged area for performing authentication and is one individual among the one or more customers; and
outputting the acquired authenticating image, wherein
when it is determined in the determining that the monitoring image includes a second customer other than the first customer, the monitoring image is output at least either before or after the output of the authenticating image.

10. A non-transitory recording medium with a store entry management program stored therein for causing a computer to execute:
acquiring a monitoring image near an entrance of a store including one or more customers before the one or more customers enter the store;
determining a number of customers included in the monitoring image;
acquiring an authenticating image including at least a part of a head of a first customer, who is in an imaged area for performing authentication and is one individual among the one or more customers; and
outputting the acquired authenticating image, wherein
when it is determined in the determining that the monitoring image includes a second customer other than the first customer, the monitoring image is output at least either before or after the output of the authenticating image.

11. The store entry management system according to claim 1, wherein,
the one or more processors are further configured to execute the instructions to:
receive a selection of either registration of an authentication image captured of the second customer or want to temporarily enter a store when a face image of the second customer has not been registered,
acquire the authenticating image of the second customer for temporary entry and store the authenticating image in a storage when receiving that the second customer wants to temporarily enter a store.
